(19) United States
(12) Patent Application Publication
(10) Pub. No.: US 2009/0319587 A1
(43) Pub. Date: Dec. 24, 2009

(54) MEMORY CONTROLLER, NONVOLATILE MEMORY DEVICE, AND NONVOLATILE MEMORY SYSTEM

(75) Inventors: Masahiro Nakanishi, Kyoto (JP); Isao Kato, Osaka (JP); Toshiyuki Honda, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/440,758

(22) PCT Filed: Sep. 5, 2007
(86) PCT No.: PCT/JP2007/067286

§ 371 Date: Apr. 22, 2009

(30) Foreign Application Priority Data
Sep. 12, 2006 (JP) 2006-246400

(51) Int. Cl. G06F 12/00

(52) U.S. Cl. 707/205; 707/E17.01; 711/E12.001

(57) ABSTRACT

An access device 150 designates a file ID for directly specifying file data to a nonvolatile memory device 120A at the time of writing file data. A file physical management part 105 in the nonvolatile memory device 120A includes a file physical management table 106 for managing, such as corresponding relationship between a physical block number of a nonvolatile memory 110 and the file ID and a block status for identifying whether the physical block is used or unused. Since a process of detecting an unused cluster by the access device 150 side is eliminated, a response in recording data can be improved.

### TECHNICAL FIELD

The present invention relates to a nonvolatile memory device such as a semiconductor memory card having a nonvolatile memory, a memory controller for controlling the nonvolatile memory, and a nonvolatile memory system configured by adding an access device as a component to the nonvolatile memory device.

### BACKGROUND ART

A nonvolatile memory device having a rewritable nonvolatile memory is increasingly demanded mainly for a semiconductor memory card. The semiconductor memory card is high-price compared to an optical disk, media of tape, and the like, however, the demand is widely increasing as a memory medium for a portable apparatus such as a digital still camera and a mobile phone because of merits such as small-size, lightweight, vibration resistance, and easy handling. This semiconductor memory card includes a flash memory as a nonvolatile main memory and has a memory controller for controlling the memory. The memory controller controls the flash memory on the reading and writing of data in accordance with reading and writing commands from the access device such as a digital still camera or a personal computer.

Such semiconductor memory card is used after attached to an access device, for example, a digital still camera. The access device handles the semiconductor memory card as a removable disk and controls the card by using a file system, for example, a FAT file system. The FAT file system manages contents, for example, an image in units of clusters by using a file allocation table (hereinafter referred to as a FAT). When the file data is written to the nonvolatile memory device, for example, the semiconductor memory card, the FAT file system allocates the file data to an unused cluster on a logical address space, and further the access device transfers, to the nonvolatile memory device, the file data and a cluster number (a logical address) to which the file data is allocated. For example, Patent document 1 discloses a nonvolatile memory system using such FAT file system in detail. The allocation management using such FAT is referred to as a “file allocation management on a logical address space”.

The file data transferred by the access device is written to the flash memory by the memory controller in the nonvolatile memory device. The memory controller obtains an unused block to store the file data on the basis of a table retaining a correspondence relationship between a logical address and a physical address and states of physical blocks (hereinafter referred to as a logical-physical management table) and writes the file data to the obtained block, and further manages a correspondence relationship between a logical address transferred by the access device and a written block on the logical-physical management table. Such nonvolatile memory device is described in detail in Patent document 2, and the writing management for file data using the aforementioned logical-physical management table is referred to as a “logical mapping management on a physical address space”

Patent document 1: Japanese Unexamined Patent Publication No. 2001-188701

Patent document 2: Japanese Unexamined Patent Publication No. 2004-152331

### DISCLOSURE OF THE INVENTION

### Problems to be Solved by the Invention

However, in these years, capacity expansion of a semiconductor memory card is accelerated in accordance with needs for storing a high-definition image. For that reason, processing for specifying clusters constituting file data managed on the FAT or processing for searching an unused cluster to which the file data is newly allocated takes longer time than ever as described above, and it becomes a major problem to shorten the time.

For example, the FAT stores information showing a linkage of clusters constituting file data and information enabling use states to be identified in units of 16 bits or 32 bits. In order to specify an unused cluster, processing for extracting clusters retaining information specifying the unused cluster (for example, a numeral value of 0x0000 or 0x00000000 in hexadecimal) from a whole of the FAT is required. The FAT management such as this extraction of unused cluster is executed by a CPU included in an access device.

Thus, when a user takes a still image with, for example, a digital still camera, the FAT management has a problem of missing a photo-opportunity as a result because it takes longer time to judge whether or not a semiconductor memory card has an unused cluster able to store the still image and which cluster is allocated to file data corresponding to the still image on the FAT. The more a capacity of the semiconductor memory card expands, the more this problem becomes serious. A response of a nonvolatile memory system side able to start the writing immediately after such writing operation by a user is referred to as a recording response.

In consideration of the above mentioned problems, the present invention intends to provide a memory controller, a nonvolatile memory device, and a nonvolatile memory system which have the superior recording response without employing the “file allocation management on a logical address space” and with reducing time required to specify an unused cluster on an access device side.

### Means to Solve the Problems

To solve the problems, a memory controller according to the present invention which is connected to a nonvolatile memory, writes file data to said nonvolatile memory in accordance with a file ID designated from an outside, and reads file data from said nonvolatile memory, comprises: a file physical management part for relating said file ID to a unit region formed by dividing an inside region of said nonvolatile memory.

Said memory controller may detect a recordable capacity of said nonvolatile memory and further comprise a recordable capacity detection part for notifying the recordable capacity to an outside.

Said file physical management part may include a file physical management table for storing, for each unit region of said nonvolatile memory, at least a recorded file ID and a status of the region.

Said memory controller may comprise a file reading-writing control part for writing file data to said nonvolatile memory and reading file data from said nonvolatile memory on the basis of a writing or reading command from an outside, and wherein while said file reading-writing control part writes file data, the file physical management part may compare the file data with a file ID as to whether or not the file data is written for updating a file stored in said nonvolatile memory, and may set a status of the unit region retaining original file data in said file physical management table to be an unused region in the case of updating the file.

Said memory controller may further comprise: a recordable capacity detection part for detecting a recordable capacity and temporarily retaining the capacity; and a recording feasibility judgment part for, based on a file size of file data designated from an outside in writing said file data and on the recording capacity retained by said recordable capacity detection part, judging whether or not said nonvolatile memory has a region to which the file data can be written, and for notifying an outside of recording feasibility.

Said file physical management part may include a file physical management table for storing, for each unit region of said nonvolatile memory, at least a recorded file ID and a status of the region.

Said memory controller may comprise a file reading-writing control part for writing file data to said nonvolatile memory and reading file data from said nonvolatile memory on the basis of a writing or reading command from an outside, and wherein while said file reading-writing control part writes file data, the file physical management part may compare the file data with a file ID as to whether or not the file data is written for updating a file stored in said nonvolatile memory, and may set a status of the unit region retaining original file data in said file physical management table to be an unused region in the case of updating the file.

To solve the problems, a nonvolatile memory device according to the present invention comprises: a nonvolatile memory; and a memory controller which is connected to a nonvolatile memory, writes file data to said nonvolatile memory in accordance with a file ID designated from an outside, and reads file data from said nonvolatile memory, wherein said memory controller includes a file physical management part for at least relating said file ID to a unit region formed by dividing an inside region of said nonvolatile memory.

To solve the problem, a nonvolatile memory system according to the present invention comprises: an access device; a nonvolatile memory; and a memory controller, wherein said access device writes and reads file data by designating a file ID to said nonvolatile memory device, and said memory controller includes a file physical management part for at least relating said file ID to a unit region formed by dividing an inside region of said nonvolatile memory, and writes file data to the nonvolatile memory and reads file data from said nonvolatile memory in accordance with the file ID designated from said access device.

### EFFECTIVENESS OF THE INVENTION

The present invention is based on a file level access method where an access device designates a file to be read or written to a nonvolatile memory device, and a file physical management part specifies correspondence relationship of a file ID designated by the access device with a data recording unit. Accordingly, the access device side is not required to search and map the management of unused clusters on a logical address space on the basis of the FAT, resulting in improvement of the recording response.

Additionally, when further comprising a recordable capacity detection part for detecting a recordable capacity and notifying the access device of the recordable capacity, or further comprising: a recordable capacity detection part for detecting a recordable capacity; and a recording feasibility judgment part for judging whether or not the nonvolatile memory has a region able to store file data on the basis of the recordable capacity and a file size of the file data designated by the access device in writing the file data and for notifying the access device of the feasibility of recording, the present invention can avoid a problem that a writing process of file data by the access device cannot be completed because of capacity shortage of the nonvolatile memory side, namely, a situation where a user is wastefully forced to wait.

### BRIEF DESCRIPTION OF DRAWINGS

FIG. 1 is a block diagram showing a nonvolatile memory system according to embodiment 1 of the present invention.

FIG. 2 is an explanation view showing a configuration of a physical block.

FIG. 3 is a flowchart showing processing of a memory controller 100.

FIG. 4A is a memory map (1) showing a file physical management table 106.

FIG. 4B is a memory map (2) showing the file physical management table 106.

FIG. 4C is a memory map (3) showing the file physical management table 106.

FIG. 5A is an explanation view (1) showing use states of physical blocks in a nonvolatile memory 110.

FIG. 5B is an explanation view (2) showing use states of physical blocks in the nonvolatile memory 110.

FIG. 5C is an explanation view (3) showing use states of physical blocks in the nonvolatile memory 110.

FIG. 6A is a time chart showing a transmission of various types of information from an access device 150 to a nonvolatile memory device 120A in file data writing.

FIG. 6B is a time chart showing a transmission and reception of various types of information between the access device 150 and the nonvolatile memory device 120A in file data reading.

FIG. 7 is a flowchart showing a writing process for file data in a normal operation.

FIG. 8 is a flowchart showing a reading process for file data in the normal operation.

FIG. 9 is a block diagram showing a nonvolatile memory system according to embodiment 2 of the present invention.

FIG. 10 is a flowchart showing processing of a memory controller in the embodiment.

FIG. 11 is a flowchart showing a writing process for file data in a normal operation in the embodiment.

FIG. 12A is a time chart showing a transmission of various types of information from the access device 150 to a nonvolatile memory device 120B in file data writing.

FIG. 12B is a time chart showing a transmission of various types of information from the access device 150 to the nonvolatile memory device 120B in file data writing.

### EXPLANATION FOR REFERENCE NUMERALS

100A, 100B Memory controller
101 Host interface
102 Buffer
103 Reading-writing control part
104 CPU
105 File physical management part
106 File physical management table
107A, 107B Recordable capacity detection part
108 Recording feasibility judgment part
110 Nonvolatile memory
120A, 120B Nonvolatile memory device
150 Access device
151 Display part

### BEST MODE FOR CARRYING OUT THE INVENTION

### Embodiment 1

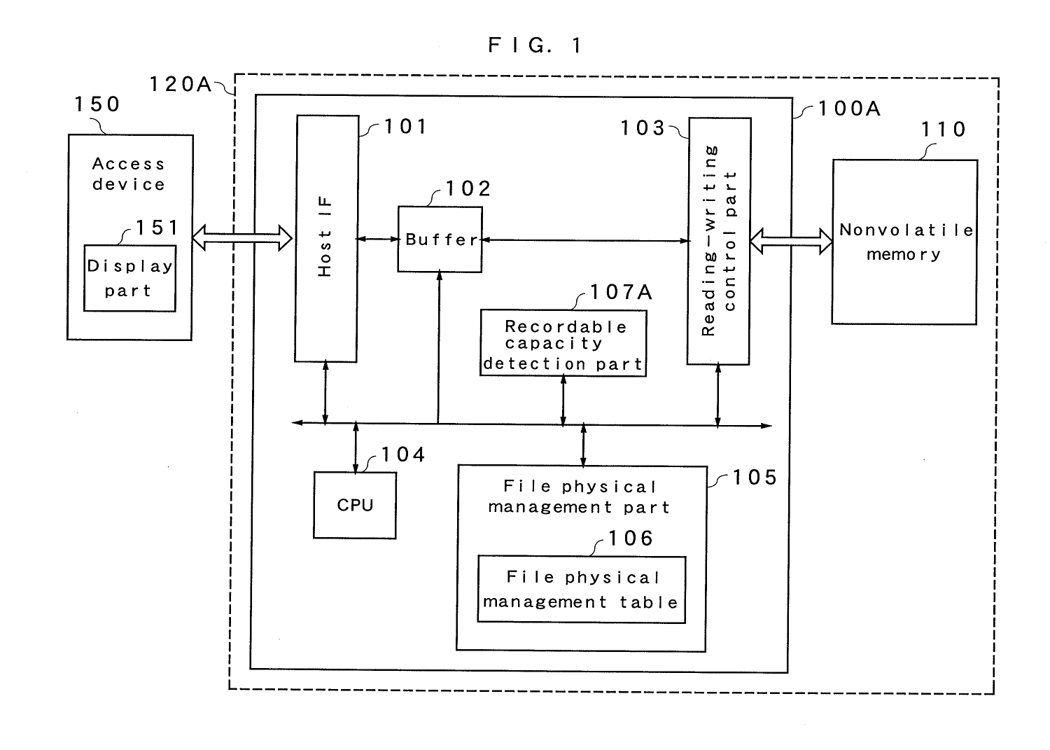

FIG. 1 is a block diagram showing a nonvolatile system according to embodiment 1 of the present invention. In FIG. 1, the nonvolatile memory system is composed of an access device 150 and a nonvolatile memory device 120A, and the nonvolatile memory device 120A includes a memory controller 100A and a nonvolatile memory 110. The memory controller 100A includes a host interface 101, a buffer 102, a reading-writing control part 103, a CPU 104, a file physical management part 105, and a recordable capacity detection part 107A.

The host interface (host IF) 101 is a block for receiving a command and a file ID both related to reading and writing of file data from the access device 150 and for transmitting and receiving the file data to and from the access device 150.

The reading-writing control part 103 writes data temporarily stored in the buffer 102 to the nonvolatile memory 110 and reads data stored in the nonvolatile memory 110 to store the data in the buffer 102.

The CPU 104 controls a whole of the memory controller 100A.

The file physical management part 105 determines and manages a physical block number of a writing target or reading target in the nonvolatile memory 110 on the basis of, for example, a command and a file ID both received from the access device 150, and includes a file physical management table 106 described later.

The recordable capacity detection part 107A counts the number of unused blocks on the basis of the file physical management table 106, detects a recordable capacity by multiplying a size of one block by the counted number, namely, a capacity of a region able to newly store file data in the nonvolatile memory 110, and further notifies the access device 150 of the recordable capacity.

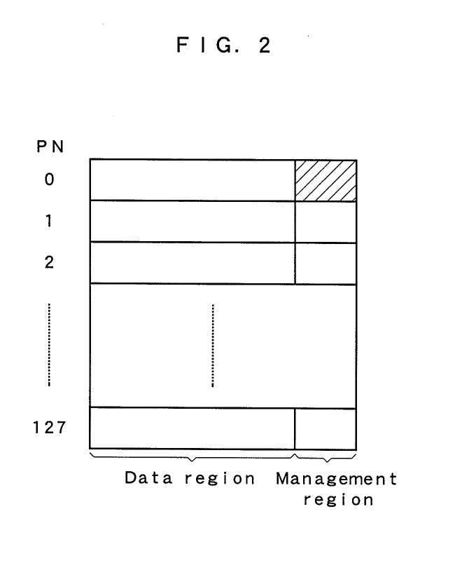

The nonvolatile memory 110 is a flash memory, and has a size of, for example, 1 GB as a user region. Supposing an erasing unit is a physical block, the nonvolatile memory 110 is composed of a plurality of physical blocks. FIG. 2 is an explanation view showing a configuration of the physical block. One physical block has a data recording size of 256 kbytes, and is composed of 128 pages of page numbers PN0 to PN127. In addition, each of the pages is a writing unit, and is composed of a 2 kbyte-data region and a 64 byte-management region. The management region of the page number PN0 stores management information of a file, for example, a file name, file size parameter, file configuration number, and block status described later.

The access device 150 writes and reads file data to and from the nonvolatile memory device 120A, and includes at least the display part 151 for displaying a recordable capacity. To simplify the description, a minimum unit of the file data is 256 kbytes same as the physical block size. For example, when a still image of 1 Mbytes is recorded, four physical blocks are used.

The nonvolatile memory system configured as described above according to the present invention will be explained separately divided into initialization processing in starting up a power source and reading-writing processing for file dada in a normal operation.

(Initialization Processing in Starting Up a Power Source)

When a power is supplied to the access device 150, the power is also supplied to the nonvolatile memory device 120A via an external bus and the memory device 120A enters the initialization processing.

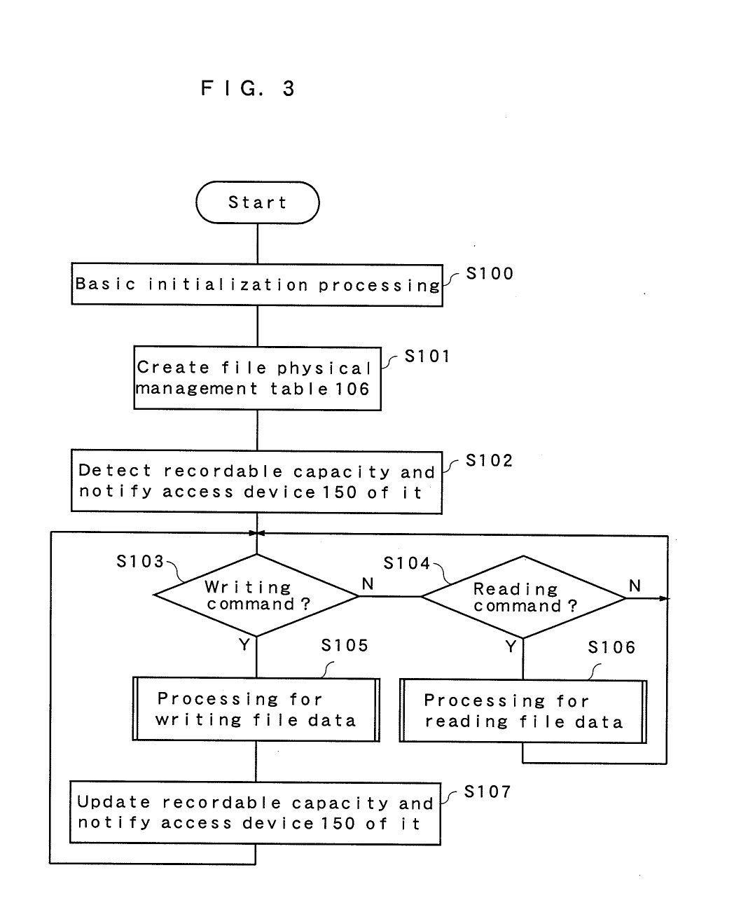

FIG. 3 is a flowchart showing processing of the memory controller 10A. In FIG. 3, the CPU 104 executes basic initialization processing, for example, processing for clearing the buffer 102 (S100). The CPU 104 subsequently creates the file physical management table 106 by searching a management region in a starting page of each physical block (S101). Specifically, the CPU 104 reads the management regions in pages PN0 of all physical blocks in the nonvolatile memory 110 via the reading-writing control part 102. Then, the CPU 104 creates the file physical management table 106 on a RAM in the file physical management part 105 on the basis of the management information stored in the management regions. In subsequent reading-writing processing for file data, the CPU 104 determines a physical block number by using the file physical management table 106.

Next, the CPU 104 passes a control to the recordable capacity detection part 107A. The recordable capacity detection part 107A detects the number of unused physical blocks on the basis of values representing a block status described below in the file physical management table 106, and calculates a recordable capacity by multiplying 256 kbytes by the counted number. Then, the recordable capacity detection part 107A temporarily retains the value, and notifies the access device 150 of the recordable capacity (S102). In this manner, the initialization processing in starting up a power completes.

The access device 150 recognizes a file size which can be stored in the nonvolatile memory device 120 on the basis of the notified recordable capacity and informs a user of the recordable capacity by displaying the recordable capacity on the display part 151 in the access device 150.

Then, a control is returned to the CPU 104, and the nonvolatile memory device enters a waiting state until the access device 150 transfers a reading or writing command via the host interface 101 (S103 and S104). When the writing or reading command is transferred, the nonvolatile memory device executes processing for writing file data (S105) and processing for reading file data (S106), respectively. After the writing of data, the recordable capacity of the nonvolatile memory 101 is reduced. Consequently, the recordable capacity detection part 107A detects the recordable capacity based on the file physical management table 106, internally retains the recordable capacity temporarily, and notifies the access device 150 of the recordable capacity (S107). After that, the processing returns to S103 again.

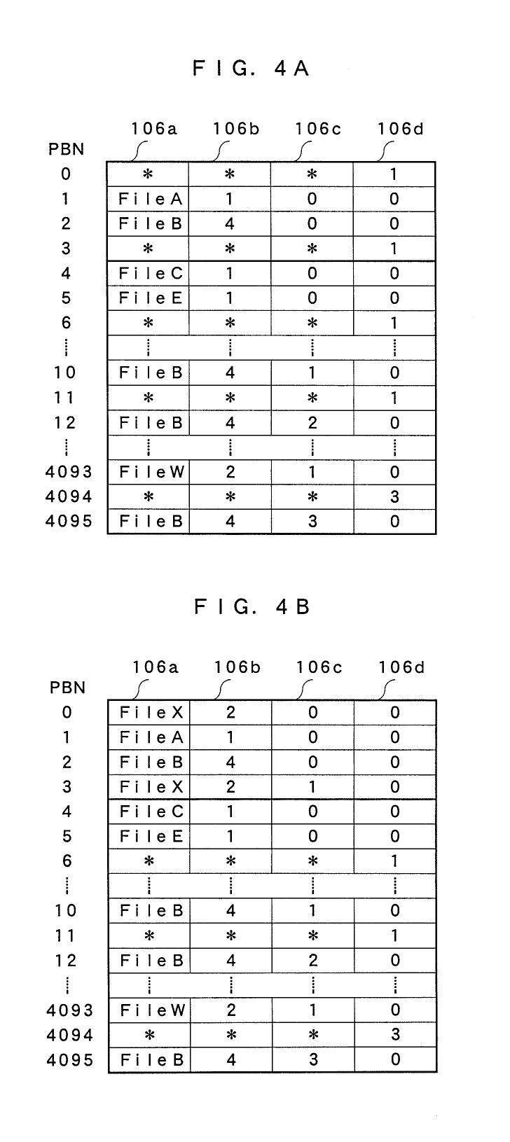

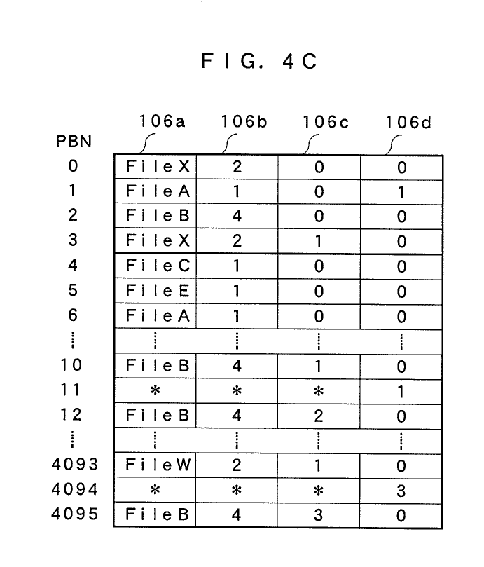

Here, referring to FIG. 4A to FIG. 4C, contents of the physical management table 106 created at S101 will be explained. The file physical management table 106 stores a file ID in a region 106a, a file size parameter in a region 106b, a file configuration order number in a region 106c, and a block status in a region 106d regarding all physical blocks from physical block numbers PBN0 to PBN 4095 of the nonvolatile memory 110. Here, a file name represented in a standard text format is employed as the file ID used for specifying a file. Instead of the file name, a file number may be employed.

FIG. 4A shows the file physical management table 106 immediately after the initialization processing. The nonvolatile memory 110 stores plural pieces of file data of file names, file A to file W (23 files in the alphabetical order), as shown in FIG. 4A. For example, in these file data, the file A is file data having a size of 256 kbytes and stored in a physical block PB1. The file B is a file having a size of 1 Mbytes and stored in physical blocks PB2, PB10, PB12, and PB4095. The file size parameter is a quotient calculated by dividing a file size by 256 kbytes, for example, a value of the parameter is 1 in a case of the file size of 256 kbytes, and a value of the parameter is 2 in a case of the file size of 512 kbytes larger than 256 kbytes. The file configuration order number is determined by a temporal order of the file data writing, for example, value “0” is given to starting 256 kbytes of file data transferred from the access device 150 and value “1” is given to next 256 kbytes. To a file recorded to one physical block, for example, the File A, value “0” is given.

The file physical management table 106 additionally includes the region 106d retaining block statuses. The block status indicates a state of each physical block by 2-bit data; value 0 represents a used block, value 1 represents an unused block (non-erased), value 2 represents a bad block, and value 3 represents an unused block (erased). In the extraction of unused blocks as S102, since a higher-order bit side in both of the values “1” and “3” is value “1” in a case of indicating the block status in 2-bit binary number, the total number of unused blocks can be detected only by searching the higher-order bit. Meanwhile, a symbol “*” indicates an arbitrary value and is actually determined to some number based on a past use state of the nonvolatile memory device 120A.

The file physical management part 105 creates the file physical management table 106 shown in FIG. 4A by searching information, for example, the file name stored in the management region in a starting page of a physical block. When file data is written to a data region of a physical block in the nonvolatile memory 110 via the reading-writing control part, the starting page of each physical block, namely, the management information in the management region of page PN0 is updated and the updated information is written to the page. FIG. 4B shows the file physical management table 106 immediately after a new writing of a file X and FIG. 4C shows the file physical management table 106 immediately after a rewriting of the file A.

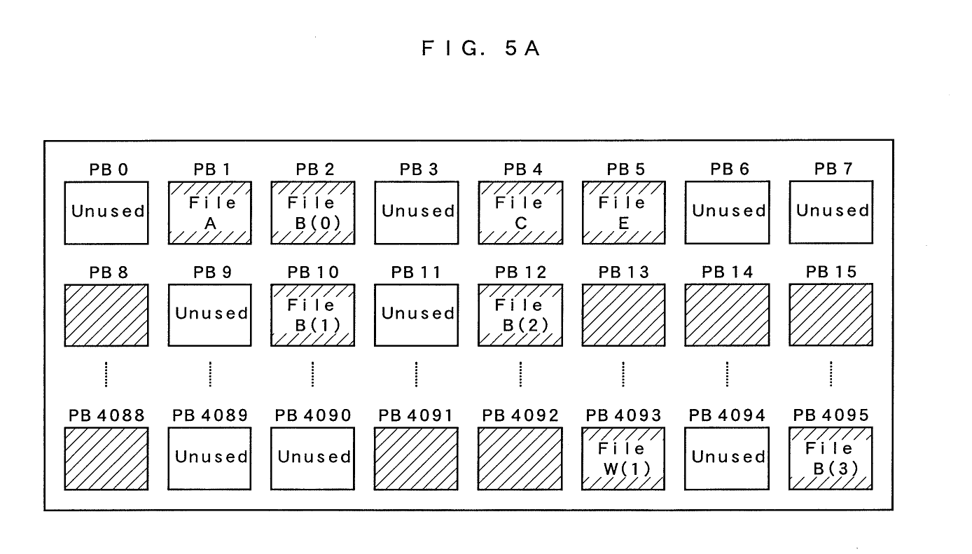

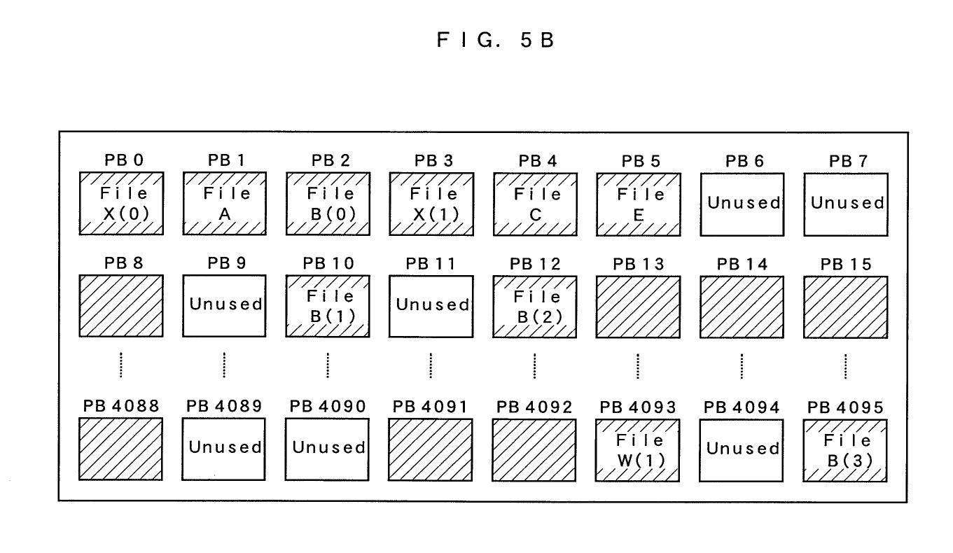

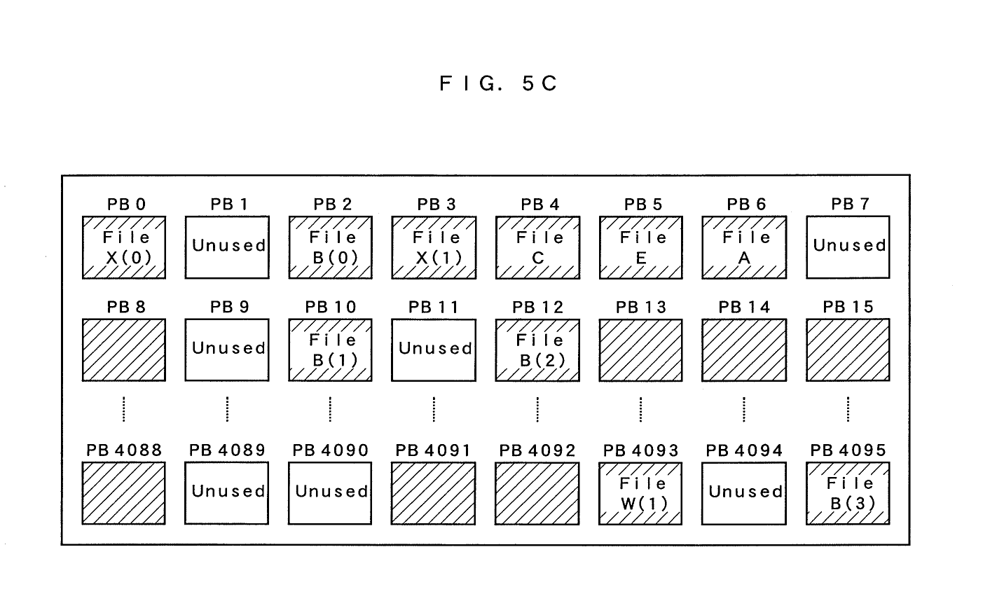

FIG. 5A to FIG. 5C are explanation views showing use statuses of physical blocks in the nonvolatile memory 110. FIG. 5A shows use statuses of physical blocks of the nonvolatile memory 110 immediately before the creation of the file physical management table 106, and corresponds to FIG. 4A. FIG. 5B shows use states of physical blocks immediately after the new writing of the file X and FIG. 5C shows use states of physical blocks immediately after the rewriting of the file A, and these figures correspond to FIG. 4B and FIG. 4C, respectively. The physical blocks with hatchings are used blocks, the physical blocks without the hatchings are unused blocks. To simplify the description, the present embodiment is supposed to include no bad block, namely, a physical block of the block status shown by the value “2”. All of the physical blocks have been erased immediately after a shipment from a manufacturer. Repetition of the writing and the erasing of file data reduces a percentage of erased physical blocks of unused blocks. To a file, for example, a file B stored striding over a plurality of physical blocks, the file configuration order numbers 0, 1, 2, and 3 are given in brackets next its file name. Meanwhile, the erasing of file data is a processing where the access device 150 orders the erasing of file data and the file physical management table 105 changes a block status in the file physical management table 106 from the value “0” to the value “1”. That is, the processing does not physically erase the data of the physical block.

(Processing for Writing File Data in the Normal Operation)

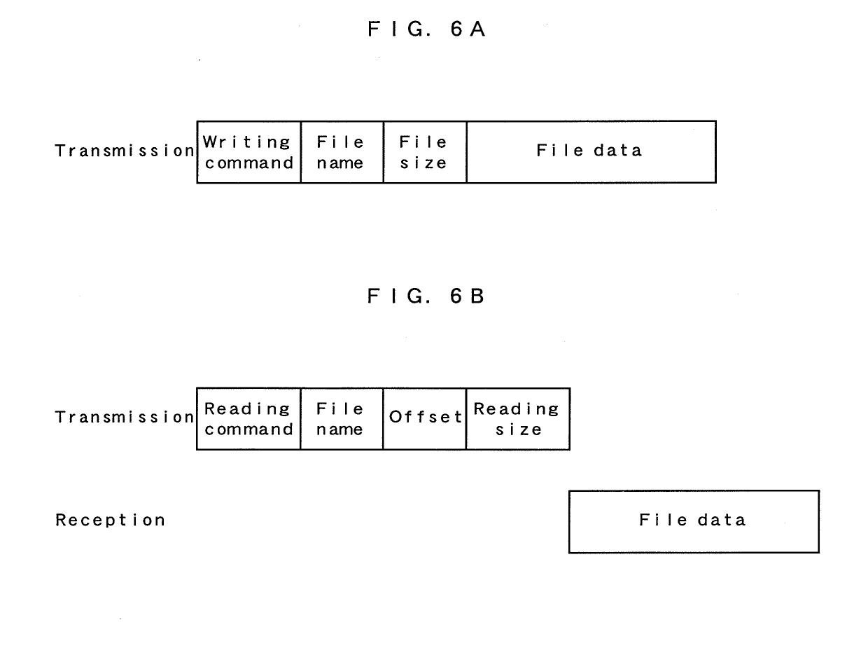

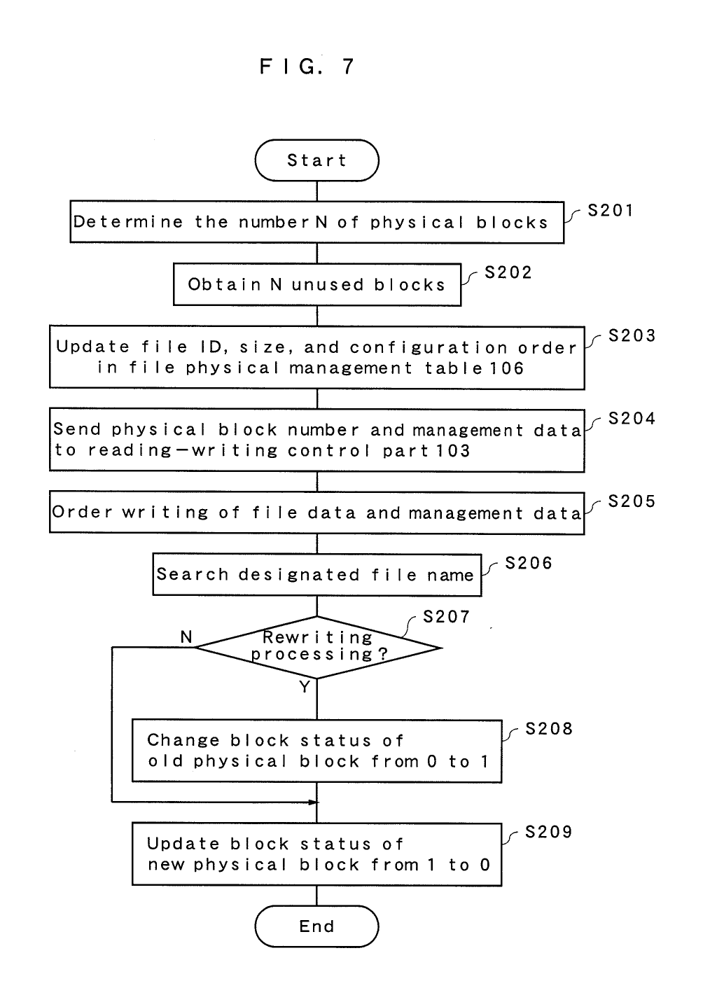

Next, processing for writing file data in the normal operation will be explained. FIG. 6A is a time chart showing transmission and reception of various types of information between the access device 150 and the nonvolatile memory device 100 in writing of file data.

In the writing of file data, as shown in FIG. 6A, the access device 150 transmits a writing command, a file name, a file size, and file data to the nonvolatile memory device 120A. The information is notifies to the CPU 104 and the file physical management part 105 via the host interface 101. The buffer 102 temporarily stores the file data. When recognizing a transmission of the writing command from the access device 150 at S103 in FIG. 3, the CPU 104 selects the writing processing at S105 and passes a control to the file physical management part 105.

FIG. 7 is a flowchart showing the processing for writing file data in the normal operation. Upon starting the writing processing, the file physical management part 105 determines the number N of physical blocks of writing targets for file data, on the basis of the file size (S201). Subsequently, referring to the file physical management table 106, the file physical management part 105 obtains N unused blocks as the writing targets (S202). As shown in FIG. 4B and FIG. 5B for example, in the case of newly writing the file X of 512 kbytes, the N will be the value “2”. The file physical management part 105 searches unused blocks in ascending order from a position of the PB0 in the file physical management table 106 after the initialization processing. Here, the file physical management part 105 obtains the PB0 and PB3 as writing targets of the file X and determines the writing order, PB0 firstly and PB3 next. Moreover, the file physical management part 105 updates the file physical management table 106 (S203). In this updating of the file physical management table 106, only the file ID, file size parameter, and file configuration order number are updated, and the block status is not updated. A start position for the searching of unused block is the position of PB0 immediately after the initialization processing, and after that the subsequent searching starts from a physical block number next to the physical block number of unused block obtained at the end of the previous searching. In this manner, the PB0 to PB4095 can be searched in a cyclic fashion, and concentration of the rewriting to a specific physical block can be avoided, that is, a wear leveling can be realized.

Next, the file physical management part 105 sends a physical block number of a writing target and management data, namely, the file name, the file size parameter, the file configuration order number, and the block status to the reading-writing control part 103 (S204). Subsequently, after erasing the writing-target physical block, the reading-writing control part 103 writes file data retained by the buffer 102 to a data region of the writing-target block. The control part simultaneously writes the file name, the file size parameter, the file configuration order number, and the block status to a management region of the writing-target block (S205).

Next, the file physical management part 105 searches whether the file name designated by the access device 150 has already been retained by the file physical management table 106, and sequentially compares the file name with file names retained by the file physical management table 106 (S206 and S207). This is carried out for judging whether the writing is a new writing or a rewriting, and if not the rewriting processing, the file physical management part 105 merely updates a block status of a new physical block to which data was written in the file physical management table 106 at step S209. In the aforementioned case, the file physical management table 106 is updated from the state of FIG. 4A to the state of FIG. 4B.

And next, after the new writing of the file X, the file A is rewritten. Since the file A has a file size of 256 kbytes, the number N of the writing-target physical blocks will be a value “1” (S201). The file physical management part 105 obtains the PB6 as a rewriting target for the file A by searching unused blocks in ascending order from a position of the PB4 in the file physical management table 106 shown in FIG. 4B, and updates the file physical management table 106 (S202 and S203).

In the case of the rewriting of the file A, since the file A exists in the PB1 in the file physical management table 106 shown in FIG. 4B, a writing command for the file A from the access device 150 is determined as the rewriting of the file A (S207).

In the case where the command was determined as the rewriting, the file physical management part 105 changes a block status of a physical block of the value “0” (old physical block) in the table 106 retaining the file name designated by the access device 150 to be the value “1” at S208. Subsequently, the management part updates the file physical management table 106 so that the status values of physical blocks of the value “0” or “3” (new physical block) can be the value “0”, and the processing completes. In the case of rewriting the file A for example, the block status of the old physical block PB1 is changed to the value “1”, and the block status of the new physical block PB6 is changed to the value “0”. Meanwhile, the subsequent comparison of a file name sometimes takes comparatively long time. However, since the comparison of a file name can be carried out during the writing to the nonvolatile memory 110 by the reading-writing control part 103 (a program busy period of a flash memory) after transferring the writing-target physical block number and the management data at S204, the comparison does not affect a total processing speed of the nonvolatile memory device 120A.

(Processing for Reading File Data in the Normal Operation)

FIG. 6B is a time chart in the reading of file data. In the reading of file data, as shown in FIG. 6B, the access device 150 sends a reading command, a file name, an offset, and a reading size to the nonvolatile memory device 120A, and receives read file data from the nonvolatile memory device 120A. The offset is a parameter indicating a starting position of the reading used for partially reading a file. In the present embodiment, units of the offset and the reading size are equivalent to a unit of physical block sizes, and correspond to the file configuration order number and the file size parameter, respectively. In the same manner of the aforementioned writing processing, the information, for example, the file name sent by the access device 150 is notified to the CPU 104 and the file physical management part 105 via the host interface 101. At S104 in FIG. 3, when recognizing the sending of the reading command from the access device 150, the CPU 104 selects the reading processing (S106) and passes a control to the file physical management part 105.

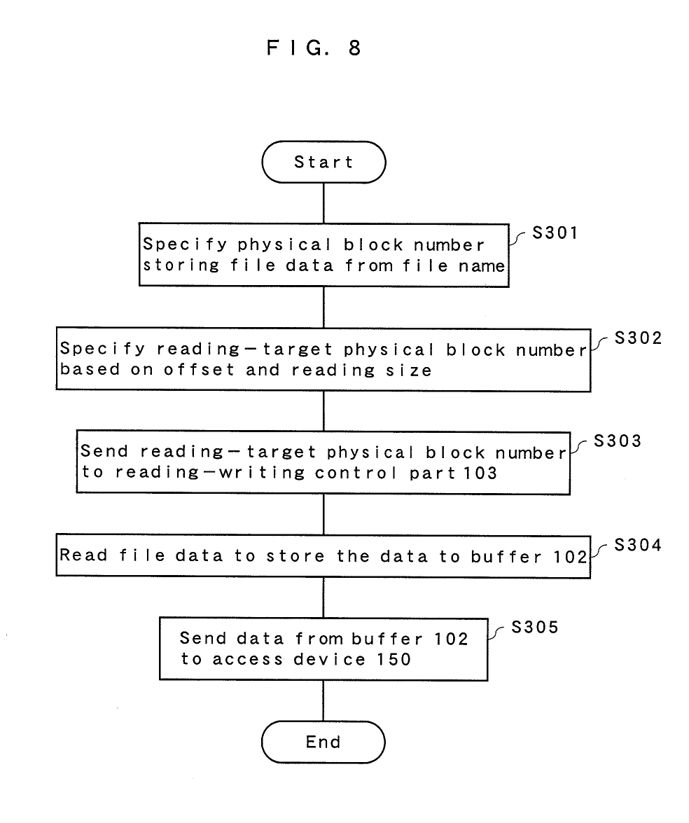

FIG. 8 is a flowchart showing the processing for reading file data in the normal operation. In FIG. 8, the file physical management part 105 specifies a physical block number storing file data corresponding to the file name by searching a file name retained in the file physical management table 106 with comparing the file name to the file name designated by the access device 150 (S301). In a case of the file B for example, the file physical management part 105 specifies the physical blocks PB2, PB10, PB12, and PB4095.

Next, the file physical management part 105 specifies a physical block number of a reading target on the basis of the offset and reading size designated by the access device 150 (S302), and sends the physical block number to the reading-writing control part 103 (S303). For example, in a case where the offset is a value “1” and the reading size is a value “1” in the reading of the file B, the reading-target physical block is PB10. In addition, the units of the offsets and reading sizes are not restricted to a physical block, and can be designated in a small unit, for example, in units of page sizes.

Then, the file physical management part 105 sends the reading-target physical block number to the reading-writing control part 103 (S303). After that, the reading-writing control part 103 reads file data from the physical block designated by the file physical management part 105 to store the data to the buffer 102 (S304). Subsequently, the CPU 104 sends the data from the buffer 102 to the access device 150 (S305).

As described above, in the nonvolatile memory system according to embodiment 1, the conventional “file allocation management on a logical address space” based on the FAT or the like is not employed. In the processing for writing or reading file data, the access device 150 designates a file ID, for example, a file name used for directly specifying file data to the nonvolatile memory device 120A and the file physical management part 105 in the nonvolatile memory device 120A reads and writes the file on the basis of the file physical management table 106. For that reason, the access device 150 is not required to detect an unused cluster on the conventional FAT, resulting in improvement of a response in recording data.

Furthermore, the recordable capacity detection part 107A notifies the access device 150 of a value, as a recordable capacity, obtained by multiplying the number of unused blocks detected on the basis of the block statuses by a size of one physical block. Thus, the present embodiment can be prevented from having a problem that a writing process of file data by the access device cannot be completed because of capacity shortage of the nonvolatile memory side, namely, a situation where a user is wastefully forced to wait.

In addition, in FIG. 3, the recordable capacity detection part 107A notifies the access device of a recordable capacity in the initialization processing and in each file writing (S102 and S107), however, the recordable capacity may be notified to the access device only in the initialization processing. In this case, the access device is required to retain the recordable capacity obtained in the initialization, to reduce a recorded data size from the recordable capacity in each file recording, and to retain the recordable capacity at that time.

### Embodiment 2

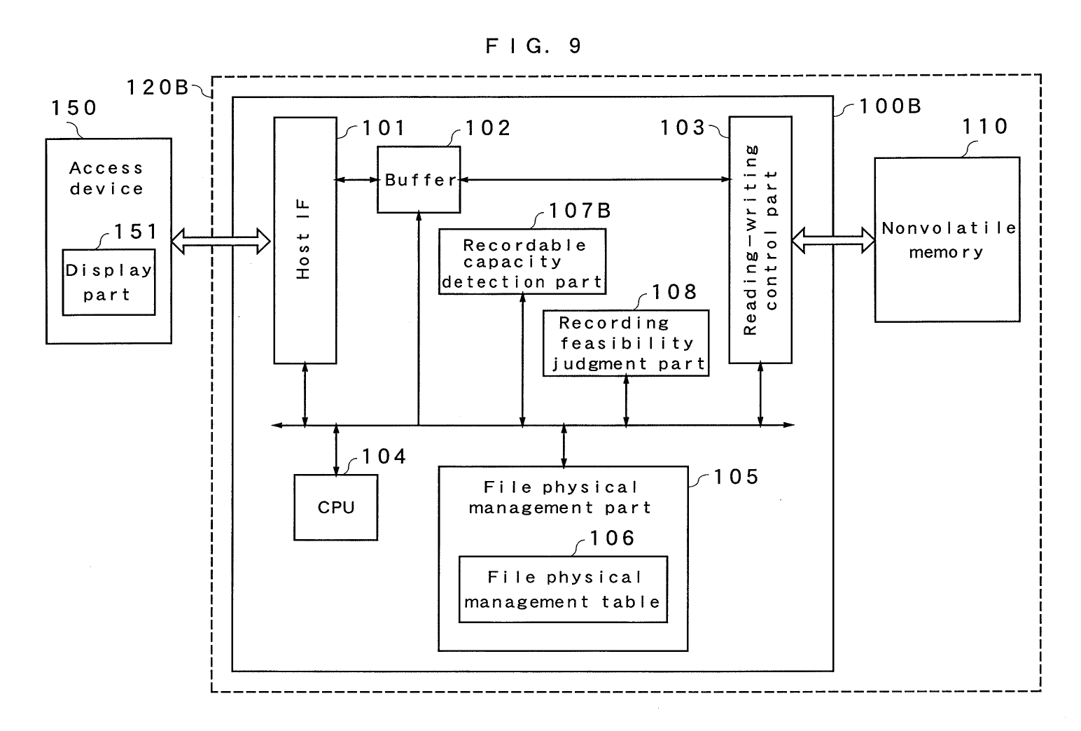

Referring to FIG. 9, embodiment 2 of the present invention will be explained. A memory controller of a nonvolatile memory device in embodiment 2 is different from that of the aforementioned embodiment 1. Detailed explanations of the same parts as those of the aforementioned embodiment 1 are omitted by giving the same numerals. In this embodiment, a memory controller 100B in a nonvolatile memory device 120B includes a recordable capacity detection part 107B and a recording feasibility judgment part 108 instead of the recordable capacity detection part 107A.

The recordable capacity detection part 107B counts the number of unused blocks on the basis of the file physical management table 106, detects a recordable capacity by multiplying a size of one block by the counted number, namely, a capacity of a region able to newly store file data in the nonvolatile memory 110, and retains the capacity.

The recording feasibility judgment part 108 judges whether or not file data of the file size can be stored, and notifies the access device 150 of a recording feasibility flag representing a feasibility judgment result.

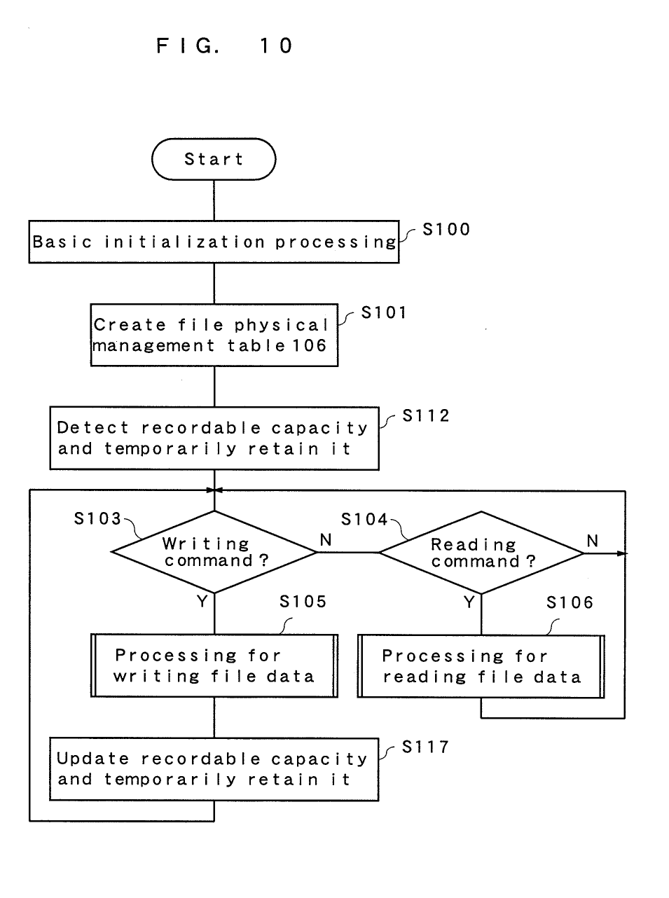

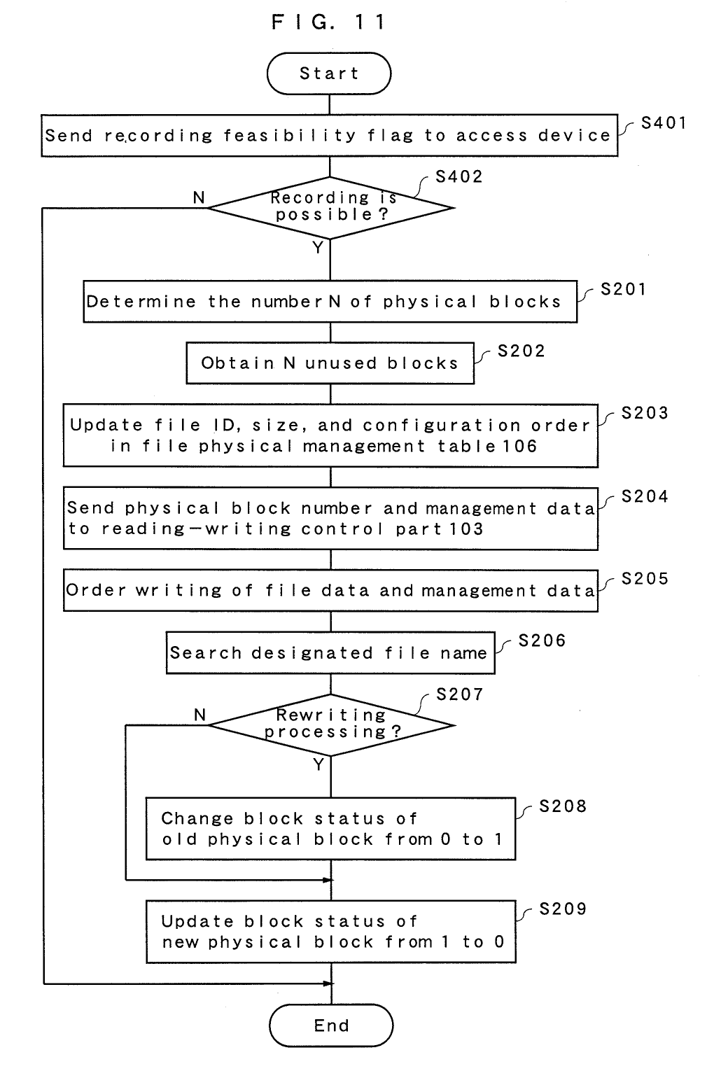

Referring to flowcharts in FIG. 10 and FIG. 11, an operation according to embodiment 2 of the present invention will be explained. In the embodiment, the basic initialization processing at S100 and S101 of the flowchart in FIG. 10 is the same processing in FIG. 3, and the recordable capacity detection part 107 detects a recordable capacity based on the file physical management table 106 and temporarily retains the capacity at S112. In addition, the processing shifts to the normal operation after completion of the initialization processing, and when a writing or reading command is issued (S103 and S104), the writing or reading processing of file data is carried out, respectively (S105 and S106). Moreover, after the completion of the data writing, the recordable capacity detection part 107B updates the recordable capacity by detecting the recordable capacity based on the file physical management table 106, and temporarily retains the capacity at S117.

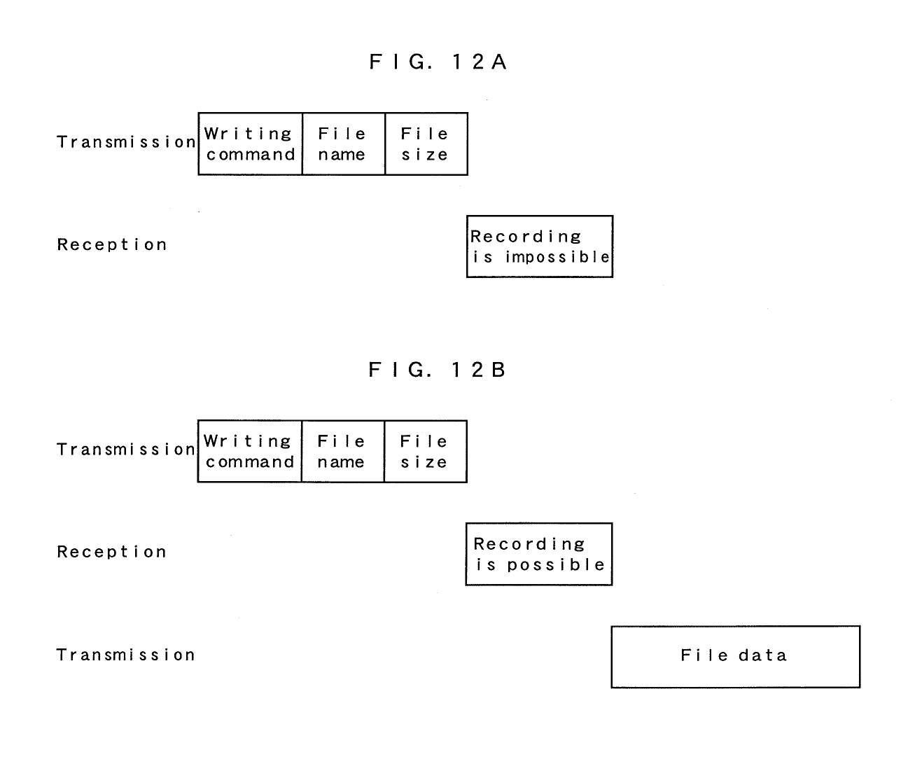

Referring to a flowchart in FIG. 11 and time charts in FIG. 12A and FIG. 12B, processing in the recording will be explained. The access device 150 firstly sends a writing command, a file name, a file size as shown in FIG. 12A. In the nonvolatile memory device as shown in FIG. 11, the recording feasibility judgment part 108 judges recording feasibility by comparing the file size designated by the access device 150 with the recordable capacity detected and temporarily retained by the recordable capacity detection part 107B, and notifies the access device 150 of a recording feasibility flag (S401). When the judgment result of the recording feasibility shows the recording is impossible, the nonvolatile memory device 120B completes the processing without writing data as shown in FIG. 12A (S402). The access device 150 can preliminarily know whether or not file data to be sent can be recorded. When the recording feasibility flag indicates a value showing impossibility of the recording, the access device 150 can cancel the sending of file data and immediately notify a user of the impossibility of the recording via the display part 151.

In the case where the recording is possible, upon receiving the flag showing the possibility, the access device 150 sends the file data after that as shown in FIG. 12B. The subsequent processing is the same as those at S201 or later of the flowchart in aforementioned FIG. 7.

In embodiment 2, since the recording feasibility judgment part 108 judges recording feasibility by comparing a recordable capacity with a file size designated by the access device 150, and notifies the access device 150 of the feasibility, the present embodiment can avoid a problem that a writing process of file data by the access device cannot be completed because of capacity shortage of the nonvolatile memory side, namely, a situation where a user is wastefully forced to wait.

In addition, the file physical management table 106 has a function for relating a file name to a physical block number, however, is not restricted to use the physical block number. A unit region formed by dividing a memory space into an arbitrary size, for example, a page number may be related to the file name. In this case, the file physical management part manages file data on the basis of the divided unit region.

Moreover, different from the flash memory, a memory which does not employ a concept of physical block, for example, a nonvolatile RAM such as a ferroelectric memory can be employed as the nonvolatile memory 110. In this case, by defining a unit region formed by dividing a memory space into a predetermined size, a file ID can be related to the unit region.

### INDUSTRIAL APPLICABILITY

The present invention proposes a method for improving a response of a nonvolatile memory system in recording data, and is useful in a still image recording and reproducing apparatus and a mobile phone both using a nonvolatile memory device, for example, a semiconductor memory card.

1. A memory controller which is connected to a nonvolatile memory, writes file data to said nonvolatile memory in accordance with a file ID designated from an outside, and reads file data from said nonvolatile memory, comprising:
a file physical management part for relating said file ID to a unit region formed by dividing an inside region of said nonvolatile memory.

2. The memory controller according to claim 1, wherein
said memory controller detects a recordable capacity of said nonvolatile memory and further comprises a recordable capacity detection part for notifying the recordable capacity to an outside.

3. The memory controller according to claim 2, wherein
said file physical management part includes a file physical management table for storing, for each unit region of said nonvolatile memory, at least a recorded file ID and a status of the region.

4. The memory controller according to claim 3, wherein
said memory controller comprises a file reading-writing control part for writing file data to said nonvolatile memory and reading file data from said nonvolatile memory on the basis of a writing or reading command from an outside, and wherein
while said file reading-writing control part writes file data, the file physical management part compares the file data with a file ID as to whether or not the file data is written for updating a file stored in said nonvolatile memory, and sets a status of the unit region retaining original file data in said file physical management table to be an unused region in the case of updating the file.

5. The memory controller according to claim 1, wherein
said memory controller further comprises:
a recordable capacity detection part for detecting a recordable capacity and temporarily retaining the capacity; and
a recording feasibility judgment part for, based on a file size of file data designated from an outside in writing said file data and on the recording capacity retained by said recordable capacity detection part, judging whether or not said nonvolatile memory has a region to which the file data can be written, and for notifying an outside of recording feasibility.

6. The memory controller according to claim 5, wherein
said file physical management part includes a file physical management table for storing, for each unit region of said nonvolatile memory, at least a recorded file ID and a status of the region.

7. The memory controller according to claim 6, wherein
said memory controller comprises a file reading-writing control part for writing file data to said nonvolatile memory and reading file data from said nonvolatile memory on the basis of a writing or reading command from an outside, and wherein
while said file reading-writing control part writes file data, the file physical management part compares the file data with a file ID as to whether or not the file data is written for updating a file stored in said nonvolatile memory, and sets a status of the unit region retaining original file data in said file physical management table to be an unused region in the case of updating the file.

8. A nonvolatile memory device comprising: a nonvolatile memory; and a memory controller which is connected to a nonvolatile memory, writes file data to said nonvolatile memory in accordance with a file ID designated from an outside, and reads file data from said nonvolatile memory, wherein
said memory controller includes a file physical management part for at least relating said file ID to a unit region formed by dividing an inside region of said nonvolatile memory.

9. The nonvolatile memory device according to claim 8, wherein
said memory controller detects a recordable capacity of said nonvolatile memory and further comprises a recordable capacity detection part for notifying the recordable capacity to an outside.

10. The nonvolatile memory device according to claim 9, wherein
said file physical management part includes a file physical management table for storing, for each unit region of said nonvolatile memory, at least a recorded file ID and a status of the region.

11. The nonvolatile memory device according to claim 10, wherein
said memory controller comprises a file reading-writing control part for writing file data to said nonvolatile memory and reading file data from said nonvolatile memory on the basis of a writing or reading command from an outside, and wherein
while said file reading-writing control part writes file data, the file physical management part compares the file data with a file ID as to whether or not the file data is written for updating a file stored in said nonvolatile memory, and sets a status of the unit region retaining original file data in said file physical management table to be an unused region in the case of updating the file.

12. The nonvolatile memory device according to claim 8, wherein
said memory controller further comprises:
a recordable capacity detection part for detecting a recordable capacity and temporarily retaining the capacity; and
a recording feasibility judgment part for, based on a file size of file data designated from an outside in writing said file data and on the recording capacity retained by said recordable capacity detection part, judging whether or not said nonvolatile memory has a region to which the file data can be written, and for notifying an outside of recording feasibility.

13. The nonvolatile memory device according to claim 12, wherein
said file physical management part includes a file physical management table for storing, for each unit region of said nonvolatile memory, at least a recorded file ID and a status of the region.

14. The nonvolatile memory device according to claim 13, wherein
said memory controller comprises a file reading-writing control part for writing file data to said nonvolatile memory and reading file data from said nonvolatile memory on the basis of a writing or reading command from an outside, and wherein
while said file reading-writing control part writes file data, the file physical management part compares the file data with a file ID as to whether or not the file data is written for updating a file stored in said nonvolatile memory, and sets a status of the unit region retaining original file data in said file physical management table to be an unused region in the case of updating the file.

15. A nonvolatile memory system comprising: an access device; a nonvolatile memory; and a memory controller, wherein
said access device writes and reads file data by designating a file ID to said nonvolatile memory device, and
said memory controller includes a file physical management part for at least relating said file ID to a unit region formed by dividing an inside region of said nonvolatile memory, and writes file data to the nonvolatile memory and reads file data from said nonvolatile memory in accordance with the file ID designated from said access device.

16. The nonvolatile memory system according to claim 15, wherein
said memory controller detects a recordable capacity of said nonvolatile memory and further comprises a recordable capacity detection part for notifying the recordable capacity to said access device.

17. The nonvolatile memory system according to claim 16, wherein
said file physical management part includes a file physical management table for storing, for each unit region of said nonvolatile memory, at least a recorded file ID and a status of the region.

18. The nonvolatile memory system according to claim 17, wherein
said memory controller comprises a file reading-writing control part for writing file data to said nonvolatile memory and reading file data from said nonvolatile memory on the basis of a writing or reading command from an outside, and wherein
while said file reading-writing control part writes file data, the file physical management part compares the file data with a file ID as to whether or not the file data is written for updating a file stored in said nonvolatile memory, and sets a status of the unit region retaining original file data in said file physical management table to be an unused region in the case of updating the file.

19. The nonvolatile memory system according to claim 15, wherein
said memory controller further comprises:
a recordable capacity detection part for detecting a recordable capacity and temporarily retaining the capacity; and
a recording feasibility judgment part for, based on a file size of file data designated from said access device in writing said file data and on the recording capacity retained by said recordable capacity detection part, judging whether or not said nonvolatile memory has a region to which the file data can be written, and for notifying said access device of recording feasibility.

20. The nonvolatile memory system according to claim 19, wherein
said file physical management part includes a file physical management table for storing, for each unit region of said nonvolatile memory, at least a recorded file ID and a status of the region.

21. The nonvolatile memory system according to claim 20, wherein
said memory controller comprises a file reading-writing control part for writing file data to said nonvolatile memory and reading file data from said nonvolatile memory on the basis of a writing or reading command from said access device, and wherein
while said file reading-writing control part writes file data, the file physical management part compares the file data with a file ID as to whether or not the file data is written for updating a file stored in said nonvolatile memory, and sets a status of the unit region retaining original file data in said file physical management table to be an unused region in the case of updating the file.
